(19) United States
(12) Patent Application Publication
(10) Pub. No.: US 2010/0107510 A1
(43) Pub. Date: May 6, 2010

(54) Attic Door Insulator

(76) Inventor: Jerry Lee Copeland, Belmont, NC (US)

Correspondence Address: JERRY LEE COPELAND, 608 SOUTH FOREST LANE, BELMONT, NC, 28012, US

(21) Appl. No.: 12/686,310

(22) Filed: Jan. 12, 2010

Related U.S. Application Data
(62) Division of application No. 11/999,680, filed on Dec. 5, 2007.
Application No. 11/999,680 is a continuation-in-part of application No. 29/243,861, filed on Dec. 1, 2005, now Pat. No. D586473.
(60) Provisional application No. 60/873,157, filed on Dec. 5, 2006.

(51) Int. Cl. E04B 1/78; E04F 13/075; E06B 1/34

(52) U.S. Cl. 52/19; 52/404.1; 52/741.3

(57) ABSTRACT

A flexible attic access cover positionable for attachment to the framework of an attic access opening of an attic access door for the purpose of reducing heat transfer between the attic and conditioned portion of a building or house.

### CROSS REFERENCE TO RELATED APPLICATIONS

This application claims the benefit of U.S. Provisional Application No. 60/873,157, filed Dec. 5, 2006; and is also a continuation-in-part of Design application Nos. 29/243,861, filed Dec. 1, 2005, each of which are incorporated by reference in their entirety. This application also incorporates by reference U.S. Provisional Application No. 60/844,434, filed Sep. 14, 2006 in its entirety. This is a divisional application of U.S. Non-Provisional Application 11/999,680, filed Dec. 5, 2007.

### BACKGROUND OF THE INVENTION

1. Field of the Invention

The present invention relates to the field of insulated attic access covers and, more specifically, an invented attic access door insulator for any type of door between the attic and a conditioned space.

2. Description of the Related Art

Conventionally, attics are insulated from the remaining portion of the house in order to minimize heat transfer between the attic and conditioned portion of the house. For example, it is not uncommon to have ample insulation in an attic floor, with an R-value of 38 or higher, to reduce heat transfer from the attic to the conditioned house during the summer, as well as reduce heat transfer from the conditioned house to the attic during the winter. However, conventional insulation is difficult and impractical to install at the point of access to the attic.

Typically, access to the attic is gained through either a folding attic stairway in the ceiling or through a knee-wall access door in a wall. With regards to the attic access opening in the wall, the attic door is difficult to insulate and the integrated door seal is easily damaged, the frame becomes warped after installation or the door is warped preventing a good seal. Typical methods to insulate the door are hanging fiberglass insulation batts to the back of the door by stapling or gluing. The insulation does not cover the door in its entirety and is usually torn off of the door during its use and when the homeowner carries articles into the attic. The use of foam board has been somewhat effective. However, the same problem exists with trying to cover the door in its entirety and the additional thickness hinders the installation so the door can open without hitting the insulation and tearing it off of the door. Also, due to the placement of the insulation, pieces of that are often torn or otherwise damaged by a person while accessing the attic, further reducing the effectiveness of the insulation and causing insulation debris to fall to the floor. Neither method of installation provides a seal for the opening and therefore the infiltration and exfiltration of the conditioned space takes place dependant upon the attic pressure versus the conditioned space pressure. The furnace and air conditioning within the home may create pressurization or depressurization. Dryer vents, bathroom exhaust fans and kitchen stove fans create a negative effect and may help draw attic air into the living space.

In addition, the variations in the dimensions of the attic access openings create a problem in fitting the covers to the attic access opening unless an enclosure is built. In most installations, the door is placed within 3 to 4 feet from the edge of the roof, thus the roof vents in the soffit allow the wind to enter the attic and blow directly against the door or in some cases creates an inductor effect to depressurize the attic.

### BRIEF SUMMARY OF THE INVENTION

The invented access cover eliminates the need to replace warped doors and frames because it conforms to the door frame and seals the frame even when the door or seal have been damaged or warped. The home owner is able to prevent outside air from the attic entering the home as well as the insulative benefits of the invented attic access cover. Furthermore, the cover insulates the door framework further reducing heat transfer between the attic and conditioned space. The frame of the invented cover is permanently attached to the exterior surfaces of the framework and creates an air space to further enhance the insulation properties of the cover.

If the attic access cover is a premium unit that has a zippered top as previously referenced in related applications, the home owner only has to unzip the cover to the side and rezip when leaving the attic. The invented method is not only practical, safer and easier to use but provides a superior permanent seal between the attic and conditioned space.

### BRIEF DESCRIPTION OF THE DRAWINGS

The above described and other features, aspects, and advantages of the present invention are better understood when the following detailed description of the invention is read with reference to the accompanying drawings, wherein:

FIG. 1 is a front view of the invented attic door access cover installed in a wall (or ceiling) for insulating a door in order to reduce heat transfer between the attic and conditioned portion of a house;

FIG. 2 is a perspective view of an attic access cover installed in a ceiling;

FIG. 3 is a left side view of the attic access cover in FIG. 2;

FIG. 4 is a top view of the attic access cover of FIG. 2;

FIG. 5 is a right side view of the attic access cover of FIG. 2;

FIG. 6 is a bottom view of the attic access cover of FIG. 2.

### DESCRIPTION OF THE PREFERRED EMBODIMENT

The present invention will now be described more fully hereinafter with reference to the accompanying drawings in which preferred embodiments of the invention are shown. This invention may, however, be embodied in many different forms and should not be considered as limited to the embodiments set forth herein. These exemplary embodiments are provided so that this disclosure will be both thorough and complete, and will fully convey the scope of the invention to those skilled in the art.

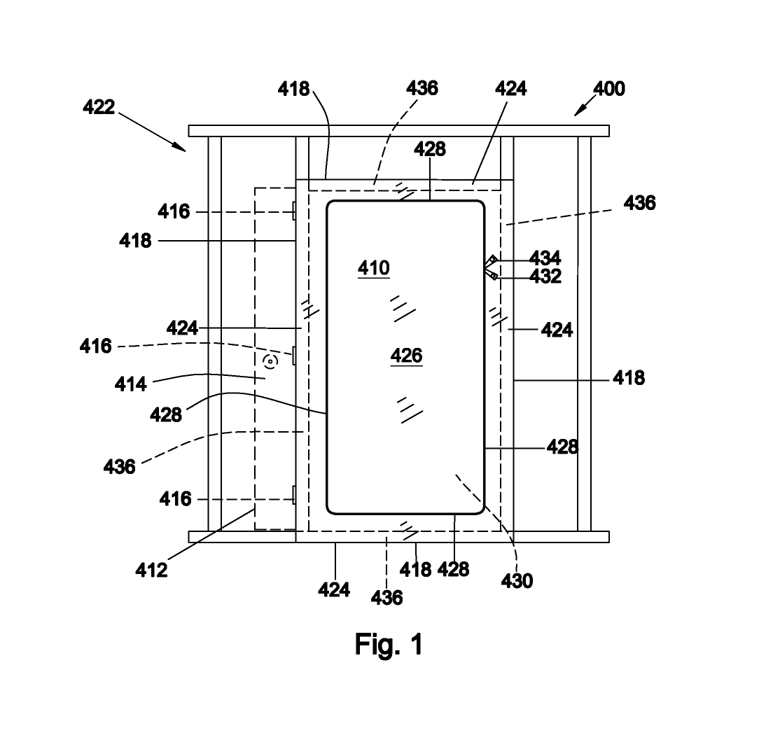

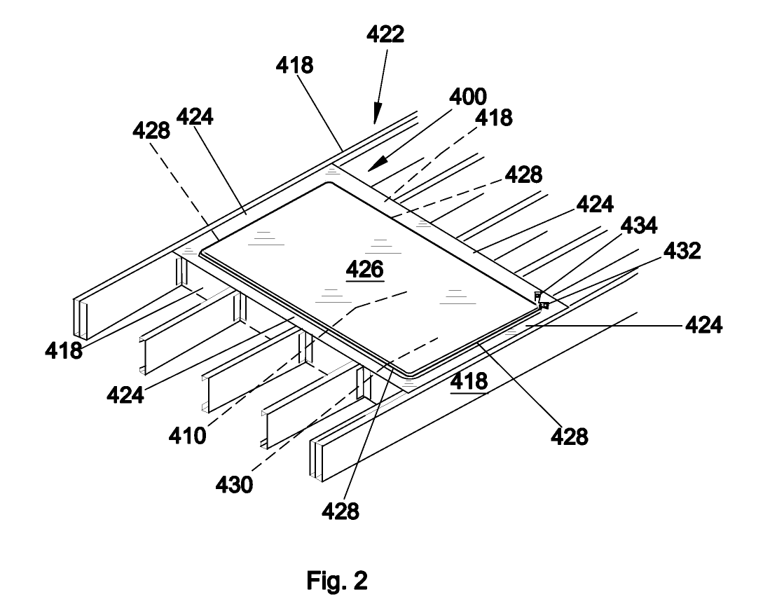

Referring to FIGS. 1-6 the invented embodiment of an attic access cover 400 for insulating an attic access opening 410 for a knee wall door 412 (FIG. 1) is illustrated. Referring to FIG. 1, the knee wall-door 412 includes a door 414, hinges 416 for allowing the door 412 to swing between an open and closed position, and framework 418 that defines the opening 410 within a wall 422 (or ceiling) of a house.

In the preferred embodiment the attic access cover 400 includes a perimeter flange 424, a top wall 426 and a zipper 428 connecting the flange 424 to the top wall 426, as illustrated in FIGS. 1-6. One-half of the zipper 428 is attached to the top wall 426 and the complementary other half of the zipper 428 is attached to the perimeter flange 424. The zipper 428 is oriented generally perpendicular to the flange 424 and top wall 426 such that the top wall 426 is projected outwards from the flange 424. The zipper 428 and top wall 426 collectively define a chamber 430 (i.e., the top wall 426 forms the top, the zipper 428 forms the sides, and the bottom is open) of air between the wall door 412 (FIG. 1) and cover 400 when the wall door is closed, thereby improving the insulation characteristics of the cover 400. By only requiring the zipper 428, (i.e., no other component to form walls) to space the top wall 426 outward from the flange 424, the cover 400 requires minimal components and little space, yet provides excellent insulative properties. Preferably, the flange 424 is unitary in construction, that is, it is uninterrupted along the perimeter direction without requiring any seams.

The top wall 426 encompasses the entire top portion of the cover 400 so that it does not interfere with ingress and egress there-through and to reduce the possibility of tripping which can otherwise cause a person to fall or damage the cover 400.

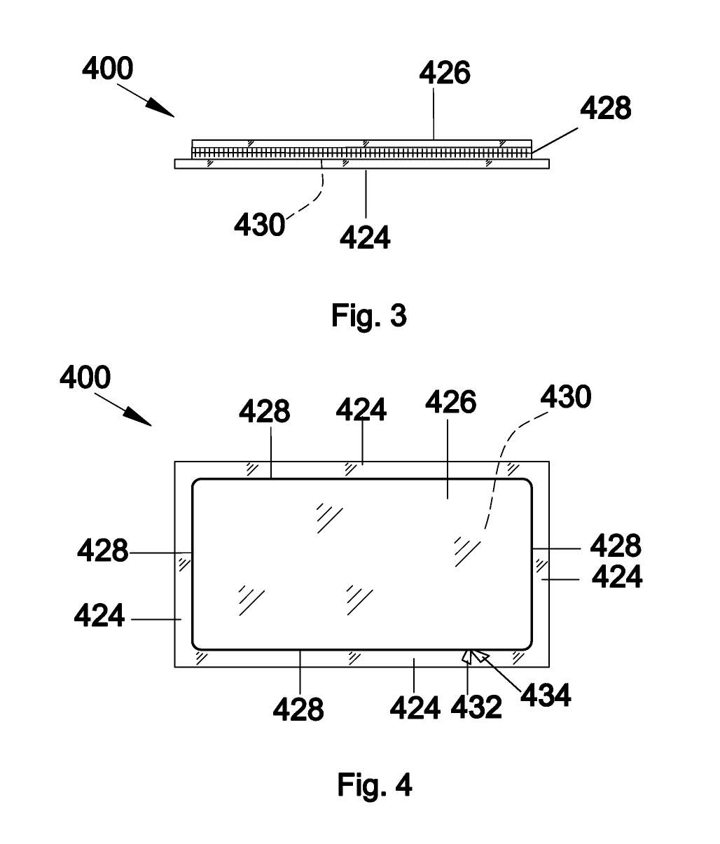

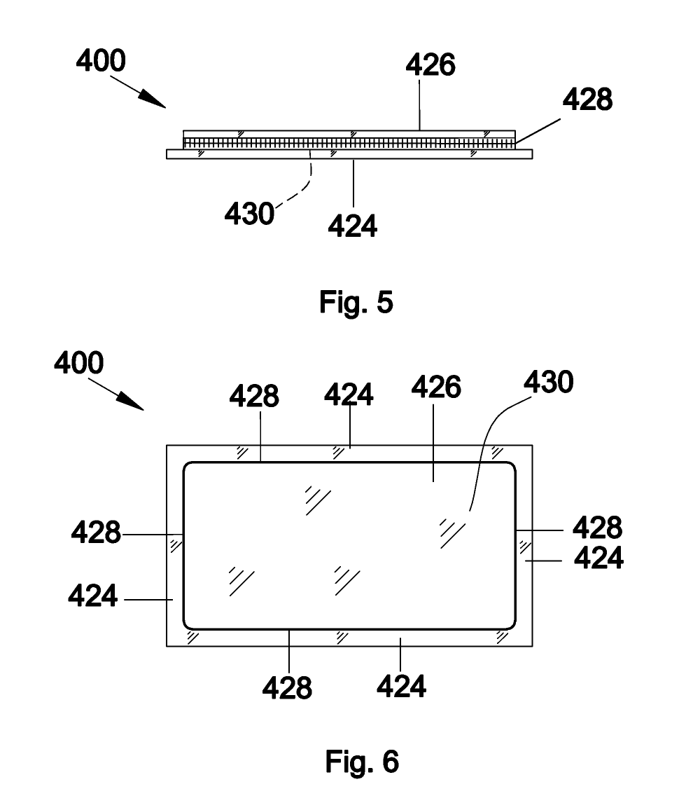

The zipper 428 forms the connection between the top 426 and the flange 424. Preferably, the zipper 428 is, or is nearly, continuous, extending around the perimeter or the top wall 426 and, thus, beginning and ending at about the same point, which preferably is at one of the corners of the zipper pathway. The zipper 428 forms a zipper pathway with rounded corners to allow for smooth movement of the zipper 428 around the perimeter of the top wall 426. By the zipper 428 being, or nearly being, continuous it forms the connection between the top wall 426 and flange 424 about which the top wall 426 hinges when being opened or closed. That is, the portion of the zipper 428 that is unzipped forms the hinge about which the top wall 426 opens and closes. Optionally, the zipper 428 may include double pulls 432, 434 so that the zipper 428 may be independently unzipped in opposite directions to allow for the cover 400 to be hingedly opened in a variety of directions. It is to be noted since the left, right, bottom and top of the cover 400 have the same configuration, other than possible differences in length, FIG. 3 showing the left side is also illustrative of the right side and, likewise, FIG. 5 showing the top is also illustrative of the bottom.

The top wall 426 and flange 424 are formed of at least one material having insulative properties. In a preferred embodiment, the are comprised of a closed cell insulation (foam) core with 99% pure aluminum laminates on both sides to reflect radiant energy, such as the insulative material sold under the name of PRODEX®. Preferably the top wall 426 has two or more layers to enhance the insulative properties of the cover 400. It is to be understood that other material may be suitably used.

The flange 424 is sized to be larger than the access opening 420 so that it may be secured to the framework 418. Preferably, the flange 424 and top wall 426 are formed of a flexible or semi-flexible material in order to properly install the cover 400 as discussed below.

In installing the cover 400, the flange 424 is secured to the outward facing surface 436 (i.e. the surface of the framework 418 that faces inward towards the attic) of the framework 418 defining the access opening 410. During installation, an installer pre-applies caulking to the outward facing surface 436 that positions the cover 400 over the opening 410 and pushes the flexible flange 424 to the framework 418 whereat the pre-applied silicone caulking adheres the flanges 424 in place. As the flange 424 is flexible, the cover 400 can be easily installed, even if the framework 418 is uneven, without requiring modification of the cover 400 or additional caulking to fill in gaps that could otherwise exist if the flange 424 was of a rigid construction.

It is to be understood that the foregoing description and specific embodiments are merely illustrative of the best mode of the invention and the principles thereof, and that various modifications and additions may be made to the apparatus by those skilled in the art, without departing from the spirit and scope of this invention.

That which is claimed is:

1. An attic access cover for sealing and insulating attic door openings comprised of:
a top wall;
a perimeter wall.

2. The cover according to claim 1 wherein said top wall is flexible or semi flexible.

3. The cover according to claim 1 wherein said perimeter wall is flexible or semi flexible.

4. The cover according to claim 1 further comprising a fastening means, wherein said fastening means attaches said top wall to said perimeter wall.

5. The cover according to claim 1 further comprising a zipper and wherein said zipper forms the junction between said top wall and said perimeter wall.

6. The cover according to claim 5 wherein one-half of said zipper is affixed to said top wall and the complementary other half of said zipper is affixed to said perimeter wall.

7. An apparatus for reducing heat transfer through a conditioned portion of a building and an unconditioned portion of a building, comprising:
a cover having a top wall and a perimeter wall, wherein said top wall and said perimeter wall define a cavity;
a framework having a exterior surface on the attic side that defines an attic access opening; and
wherein said perimeter wall is attached to said exterior surface of said framework.

8. The apparatus according to claim 7 wherein said perimeter wall is flexible or semi flexible.

9. The apparatus according to claim 7 wherein said cover further includes a zipper and wherein said zipper forms a junction between said top wall and said perimeter wall.

10. The apparatus according to claim 7 wherein said zipper forms the sides of said cover to form a chamber.

11. The apparatus according to claim 9 wherein said zipper junction allows said cover to pivot when said top wall is being moved between an open and closed position.

12. The apparatus according to claim 7 wherein said perimeter wall includes a top, bottom, left side and right side and wherein said top, bottom, left side and right side are attached to said exterior surfaces of said framework.
